(19) United States
(12) Patent Application Publication
(10) Pub. No.: US 2014/0278742 A1
(43) Pub. Date: Sep. 18, 2014

(54) STORE-WIDE CUSTOMER BEHAVIOR ANALYSIS SYSTEM USING MULTIPLE SENSORS

(71) Applicants: Michael Joseph MacMillan, Hong Kong (HK); HO CHOW CHAN, Hong Kong (HK)

(72) Inventors: Michael Joseph MacMillan, Hong Kong (HK); HO CHOW CHAN, Hong Kong (HK)

(21) Appl. No.: 13/832,416

(22) Filed: Mar. 15, 2013

(51) Int. Cl. G06Q 30/02

(52) U.S. Cl. CPC G06Q 30/0201
USPC 705/7.29

(57) ABSTRACT

A system for analyzing a customer's behavior in a store is provided. The system includes a data capturing unit, which has a first sensor configured to capture an image and an activity of the customer at a preset interval in the store during a first time period when the customer navigates a pre-defined area. The system also includes a data processing unit for processing the image and activity of the customer, which creates a behavior file for the customer from the image and the activity captured by the data capturing unit, and creates a statistics for activities of a plurality of customers in the store for a pixel or a predefined zone in the store for a pre-defined second time period wherein the statistics value is set at zero at the beginning of the pre-defined second time period. The system further includes a data reporting unit for presenting the statistics.

### FIELD OF INVENTION

This invention relates generally to systems for behavior analysis and, more particularly, to systems for behavior analysis of the people using multiple sensors.

### BACKGROUND

The retail channel is often referred to as the “dark channel” as it is difficult to analyze the customer behavior in a store due to the lack of available data. While the purchase data may be readily available based on the point of sales data and loyalty programs, other data, such as customers' activities within the store, may not be obtained easily. Thus, retailers lack the data on customer's behavior in store, such as the data on a customer's navigation in a store, the customer's interaction with the shopping environment, and the customer's purchase decision. As a result, a retailer may be unable to analyze and understand the customer's decision making and make adjustment to promote sales based on reliable data.

The disclosed system and process are directed at solving one or more problems set forth above and other problems.

### BRIEF SUMMARY OF THE DISCLOSURE

One aspect of the present disclosure provides a system for analyzing a customer's behavior in a store. The system includes a data capturing unit, which has a first sensor configured to capture an image and an activity of the customer at a preset interval in the store during a first time period when the customer navigates a pre-defined area. The system also includes a data processing unit for processing the image and activity of the customer, which creates a behavior file for the customer from the image and the activity captured by the data capturing unit, and creates a statistics for activities of a plurality of customers in the store for a pixel or a predefined zone in the store for a pre-defined second time period wherein the statistics value is set at zero at the beginning of the pre-defined second time period. The system further includes a data reporting unit for presenting the statistics.

Another aspect of the present disclosure provides a process for analyzing a customer's behavior in a store. The process includes capturing an image and an activity of a customer at a preset interval during a first time period when the customer navigates a pre-defined area using a data capturing unit. The data capturing unit has a first sensor configured to capture the image and the activity of the person. The process also includes creating a behavior file for the customer from the image and the activity captured by the data capturing unit, and creating a statistics for activities of a plurality of customers in the store for a pixel or a predefined zone in the store for a pre-defined second time period wherein the statistics value is set at zero at the beginning of the pre-defined second time period using a data processing unit. The process further includes presenting the statistics using a reporting unit.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary system consistent with the disclosed embodiments;

FIG. 2 illustrates block diagram of an exemplary computing system consistent with the disclosed embodiments;

FIG. 3 illustrates an exemplary data capturing unit in a store consistent with the disclosed embodiments;

FIG. 4 illustrates an exemplary process performed by the system to create customer's behavior report consistent with the disclosed embodiments;

FIG. 5 illustrates an exemplary arrangement of a plurality of sensors consistent with the disclosed embodiments;

FIG. 6 illustrates an exemplary traffic path creation performed by the data processing unit consistent with the disclosed embodiments;

FIG. 7 illustrates an exemplary exclusion of non human objects from image file performed by the data processing unit consistent with the disclosed embodiments;

FIGS. 8A-8D illustrate exemplary tracking statistics creation performed by the data processing unit consistent with the disclosed embodiments;

FIG. 9 illustrates an exemplary counting statistics creation performed by the data processing unit consistent with the disclosed embodiments;

FIG. 10 illustrates an exemplary process to create various statistics performed by the data processing unit consistent with the disclosed embodiments;

FIG. 11 illustrates exemplary staff exclusions performed by the data processing unit consistent with the disclosed embodiments;

FIG. 12 illustrates an exemplary staff identification performed by the data processing unit consistent with the disclosed embodiments;

FIG. 13 illustrates an exemplary staff-to-customer interaction detection performed by the data processing unit consistent with the disclosed embodiments;

FIG. 14 illustrates an exemplary process performed by the data processing unit to create staff-to-customer interaction statistics consistent with the disclosed embodiments;

FIG. 15A illustrates an exemplary touch statistics creation performed by the data processing unit consistent with the disclosed embodiments;

FIG. 15B illustrates an exemplary process to create a touch statistics performed by the data processing unit 104 consistent with the disclosed embodiments;

FIG. 16 illustrates an exemplary bailout statistics creation performed by the data processing unit consistent with the disclosed embodiments;

FIGS. 17A and 17B illustrate an exemplary view statistics creation performed by the data processing unit consistent with the disclosed embodiments;

FIG. 18 illustrates an exemplary process to create a view number and view time statistics performed by the data processing unit consistent with the disclosed embodiments.

FIG. 19 illustrates an exemplary data temporary storage in the data processing unit consistent with the disclosed embodiments;

FIG. 20 illustrates an exemplary process performed by the data processing unit for the temporary storage of the statistics;

FIG. 21 illustrates an exemplary integration of different type of data performed by the reporting unit consistent with the disclosed embodiments;

FIG. 22 illustrates an exemplary integration of point of sales data with the customer's behavior data performed by the reporting unit consistent with the disclosed embodiments;

FIGS. 23A-23C illustrate exemplary presentations created by the reporting unit consistent with the disclosed embodiments;

FIG. 24 illustrates an exemplary adjacency presentation created by the reporting unit consistent with the disclosed embodiments;

FIG. 25 illustrates an exemplary presentation of the traffic path statistics in map data layer consistent with the disclosed embodiments;

FIG. 26 illustrates an exemplary process performed by the reporting unit to create a map data layer consistent with the disclosed embodiments;

FIG. 27 illustrates an exemplary process performed by the reporting unit to assign a statics value for a pixel on the floor consistent with the disclosed embodiments;

FIGS. 28A-28C illustrate an exemplary sensor mapping performed by the reporting unit consistent with the disclosed embodiments;

FIG. 29 illustrates an exemplary fixture layer presentation of customer's activity in a store;

FIGS. 30A and 30B illustrate exemplary fixture area definitions consistent with the disclosed embodiments;

FIG. 31 illustrates an exemplary process performed by the reporting unit to create a fixture layer consistent with the disclosed embodiments;

FIGS. 32-35 illustrate exemplary fixture layer presentations consistent with the disclosed embodiments; and

FIG. 36 illustrates an exemplary three-dimensional map presentation performed by the reporting unit consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

FIG. 1 illustrates an exemplary system consistent with the disclosed embodiments. As shown in FIG. 1, a system 100 includes a data capturing unit 102, a data processing unit 104, a data storage unit 106, and a reporting unit 108. The data capturing unit 102 is installed in the store. The data processing unit 104 is also usually installed in store, which may be an independent device or integrated with the data capturing unit 102. The data processing unit 104 may also be installed remotely. The data storage unit 106 and the reporting unit 108 may be installed in the store or may be installed remotely in a head office and may be shared across multiple stores. The data processing unit 104, the data storage unit 106 and the reporting unit 108 may be integrated in a system or may be separated. The data transfer between different units may be achieved through a network connection such as ADSL line, wireless connection, or any form of internet connection.

The various units, e.g., the data processing unit 104, the data storage unit 106, and the reporting unit 108, may be implemented using any appropriate computing systems. FIG. 2 shows a block diagram of an exemplary computing system 200.

As shown in FIG. 2, computing system 200 may include a processor 202, a random access memory (RAM) unit 204, a read-only memory (ROM) unit 206, a database 208, an input/output interface unit 210, a storage unit 212, and a communication interface 214. Other components may be added and certain devices may be removed without departing from the principles of the disclosed embodiments.

Processor 202 may include any appropriate type of graphic processing unit (GPU), general-purpose microprocessor, digital signal processor (DSP) or microcontroller, and application specific integrated circuit (ASIC), etc. Processor 202 may execute sequences of computer program instructions to perform various processes associated with computing system 200. The computer program instructions may be loaded into RAM 204 for execution by processor 202 from read-only memory 206.

Database 208 may include any appropriate commercial or customized database to be used by computing system 200, and may also include query tools and other management software for managing database 208. Further, input/output interface 210 may be provided for a user or users to input information into computing system 200 or for the user or users to receive information from computing system 200. For example, input/output interface 210 may include any appropriate input device, such as a remote control, a keyboard, a mouse, a microphone, a video camera or web-cam, an electronic tablet, voice communication devices, or any other optical or wireless input devices. Input/output interface 210 may include any appropriate output device, such as a display, a speaker, or any other output devices.

Storage unit 212 may include any appropriate storage device to store information used by computing system 200, such as a hard disk, a flash disk, an optical disk, a CR-ROM drive, a DVD or other type of mass storage media, or a network storage. Further, communication interface 214 may provide communication connections such that computing system 200 may be accessed remotely and/or communicate with other systems through computer networks or other communication networks via various communication protocols, such as TCP/IP, hyper text transfer protocol (HTTP), etc.

The data capturing unit 102 may include one or more sensors capable of capturing an image or an activity of a customer within a store. FIG. 3 illustrates an exemplary data capturing unit 102 in a store consistent with the disclosed embodiments. As shown in FIG. 3, the data collecting unit 102 includes one or more first sensors 302. The sensor 302 may be a conventional security camera, a time of flight sensor, a stereoscopic camera, an infra-red sensor, or any sensor capable of capturing the image or the activity of a person 110 within the store. Other types of sensors may also be used. The sensor 302 may be installed at any proper locations such as the ceiling of the store or on the wall near the floor. The sensor 302 may be oriented at certain directions to capture the image and movement of the person 110.

The data capturing unit 102 may further include one or more second sensors 304. As shown in FIG. 3, the sensors 304 are usually installed on a fixture 112 within the store. The second sensor 304 may be a conventional security camera, a time of flight sensor, a stereoscopic camera or an infra-red sensor. Other types of sensors may also be used. The sensor 304 may be located at a height that is approximately the average height of human. Thus, the sensor 304 may be used to capture the face image of the person 110. The sensor 304 may also be located at any other locations and may be configured to capture the face image of the person 110.

Returning to FIG. 1, the data capturing unit 102 may capture the image and the activity of the person 110. The image and the activity of the customer may be sent to the data processing unit 104, wherein the traffic path of the person 110 is created. The data processing unit 104 may further create various statistics for the customers' activities in the store. The data created in the processing unit 104 may be sent to the data storage unit 106 for storage. The data created in the processing unit 104 may also be sent to the reporting unit 108 to create various reports. The data stored in the storage unit 106 may also be retrieved and sent to the reporting unit 108 to create various reports. FIG. 4 shows an exemplary process 400 performed by the system 100 to create various reports consistent with the disclosed embodiments.

As shown in FIG. 4, at beginning, the sensor 302 or 304 of the data capturing unit 102 captures an image or an activity of a person (e.g., the person 110) at a pre-set interval (402). The image and the activity of the person 110 may be sent to a device, such as a computer, in the data processing unit 104. After receiving the images and the activities for a preset time period or within a pre-defined zone, the data processing unit 104 may determine whether the person 110 is a staff member (404). If the person 110 is not a staff member (i.e., a customer), a behavior file of the person 110 may be created (406). The behavior file may include a traffic path file. Such a traffic path file may include the information such as the location of the customer 110 (i.e., spatial data) at a particular time point (i.e., temporal data). Based on the traffic path data of the customer, the statistics of the behavior of a plurality of customers may be created (408). The statistics may be sent to the reporting unit 108 and reports may be created (410). If the person 110 is a staff member, the information regarding this staff member may be discarded or used to create staff member statistics.

To capture the image and activity of the person 110, a plurality of the sensors 302 are arranged in such a manner that at least one sensor may capture the image and the activity of the person 110. FIG. 5 illustrates an exemplary arrangement of a plurality of sensors 302 consistent with the disclosed embodiment. As shown in FIG. 5, the arrangement of a plurality of sensors 302A, 302B, 302C, and 302D is configured to cover a pre-defined area 114. The pre-defined area 114 may be an entire store, or certain area within the store. There may be a fixture 112 in the area 114, which may block the sensor 302A, but the sensor 302B may capture the image and activity of the person 110. Thus, at least one of the sensors 302A, 302B, 302C, and 302D may capture the image and/or behavior of the customer 110 at any time when the person 110 navigates in the area 114, leaving a traffic path 116.

FIG. 6 illustrates an exemplary traffic path creation performed by the data processing unit 104 consistent with the disclosed embodiments. As shown in FIG. 6, the sensor 302 captures the image of a customer 110C at pre-set interval to create an image frame 118, from the start time T₀ to the end time T₁. The image frame 118 includes the image of the customer 110C and the fixture 112 of the store in the pre-defined area 114. Each image frame 118 is also time stamped. Multiple image frames 118 are then transmitted to a data processing device 306, which may be a computing system and is a component of the data processing unit 104. Using background removal/moving object detection algorithm, a file 122 including the image of the customer 110C and his/her traffic path 116 may be created by extracting from the image frames 118 the image and the location of the customer 110C at each time point. The time point along the traffic path 116 may also be included in the file 122.

The sensor 302 may also capture a video including the customer 110C and his/her traffic path 116. The file 122 may be created from the video feed.

FIG. 7 illustrates an exemplary exclusion of non human objects from image file performed by the data processing unit 104 consistent with the disclosed embodiments. As shown in FIG. 7, the image file 122 may include the customer 110C and his/her traffic path 116; it may also include a non-human moving object 110A and its traffic path 116A. By using pattern recognition algorithm, the likelihood of the moving object 110A being a human being is determined. If the likelihood is lower than a predefined threshold value, the moving object 110A is excluded from the file 122 and a new file 124 is created to include the customer 110C and his/her traffic path 116 only for further processing.

FIGS. 8A-8D illustrate exemplary tracking statistics creation in the data processing unit 104 consistent with the disclosed embodiments. FIG. 8A illustrates an exemplary division of the pre-defined area 114 into pixels 126. As shown in FIG. 8A, the pre-defined area 114 is divided into the pixels 126. As shown in FIG. 8B, for a particular pixel 126, when a traffic path 116 intersects with the pixel 126, a traffic path value Vₜₚ is increased by one.

FIG. 8C illustrates an exemplary stop and dwell time data statistics creation performed by the data processing unit 104. For the pixel 126, the path 116 enters the pixel 126 at a time point T₂ and remains within a Minimum Stop Distance predefined by the user from pixel 126 until at a time point T₃. The time the customer 110C spent in the pixel 126 T_{A} may be calculated by subtracting T₂ from T₃ (i.e., T_{Δ}=T₃−T₂). If T_{Δ} is greater than a Minimum Stop Time predefined by the user, a stop event occurs at pixel 126 and the stop value Vₛ for the pixel 126 is increased by one and the dwell time T_{d} is increased by T_{Δ}.

FIG. 8D illustrates an exemplary direction traffic path data processing performed by the data processing unit 104. As shown in FIG. 8D, for the pixel 126, eight direction values are defined, D₁ for up direction, D₂ for down direction, D₃ for right direction, D₄ for left direction, D₅ for up-right direction, D₆ for up-left direction, D₇ for down-right direction, and D₈ for down-left direction. The pixel 126 has eight (8) adjacent pixels, 126D1, 126D2, 126D3, 126D4, 126D5, 126D6, 126D7, and 126D8. For the pixel 126 the path 116 encounters, the direction of the path 116, Dp, is determined by the two center points of the two adjacent pixels that the path 116 cross. The value of the predefined direction that corresponds to the traffic path direction is increased by one. For example, as shown in FIG. 8D, the left direction D₄ corresponds to the traffic path direction generally running from center Ca to center Cb and is increased by one. The result then indicates the movement of a customer towards each of the directions.

FIG. 9 illustrates an exemplary counting statistics creation performed by the data processing unit 104 consistent with the disclosed embodiments. Counting statistics is the number of passes by people walking through a pre-defined count zone 128, which can be the store entrance, a fitting room entrance, escalators to other floors or simply walkways as well as other logical areas. The count zone 128 is usually in a shape a polygon, typically a rectangle, in the camera view. To collect counting statistics, each edge of the count zone 128 may be defined as IN edge, OUT edge, or inactive edge. For the rectangular count zone 128 as shown in FIG. 9, the top edge may be defined as IN edge and the bottom edge as OUT edge. As shown in FIG. 9, a path 130 has two consecutive intersections in opposite directions (i.e. intersecting an IN edge then an OUT edge, or an OUT edge then an IN edge), and a pass event occurs. The count value V_{c} is thus increased by one for the count zone 128. By contrast, because a path 132 has two consecutive intersections on the same edge (the IN edge in the example shown), no pass event occurs on the path 132 and the count value V_{c} is not affected by the path 132. The shape, the IN edge, the OUT edge and the inactive edge for the count zone 128 may be defined empirically.

FIG. 10 illustrates an exemplary process 500 to create various statistics performed by the data processing unit 104 consistent with the disclosed embodiments. As shown in FIG. 10, at beginning, the statistics value is set at zero at the beginning of a predefined time period (502). The predefined time period may be a day, a week, a month, or any other predefined period. The statistics values may include Vₜₚ, Vₛ, T_{d}, Dᵢ (i may be a number between 1 and 8), and V_{c}. The data processing unit 104 may input images or video from the data capturing unit 102 (504). The data processing device 306 may then determine whether the moving subject is a human being (506). This may be achieved by using pattern recognition algorithm. If the device 306 decides that the moving subject is not a human being, the moving subject is excluded from further processing (514).

On the other hand, if the data processing device 306 decides that the moving subject is a human being, the data processing unit 104 may create the traffic path file 122 using background removal/moving object detection algorithm (508). The data processing device 306 may create various customer behavior statistics of from the traffic path files 122 for a plurality of the customers 110C (510). The customer behavior statistics may be output to data storage unit 106 and/or the reporting unit 108 (512). The customer behavior statistics may be stored temporarily in the data processing unit 104 before the output at pre-set intervals.

After the time period of data process, the customer behavior statistics values are reset at zero for the next round of data processing. Or newer values may be simply input into the temporary store memory to overwrite the older data. For each set of the value, the time period for statistics creation may or may not be the same and the resetting of the value may or may not be simultaneous. For example, the time period for traffic path statistics may be for one day and the time period for counting statistics may be for one week.

As staff stay and move in and around the store, they may impact the counting and tracking statistics significantly. FIG. 11 illustrates exemplary staff exclusions performed by the data processing unit 104 consistent with the disclosed embodiments. As shown in FIG. 11, a person 110E may be identified by a sensor 308, which receive a signal from the person 110E, such as the electromagnetic signal on an identification card. The person 110E is thus identified as a staff member and excluded from customer data/statistics processing.

In certain embodiments, the staff member 110E may be identified using behavior pattern recognition algorithm. As shown in FIG. 11, the person 110E's traffic path 116E intersects with a staff zone 134. The person 110E enters the staff zone 134 at a time point T₄ and leaves at a time point T₅. If the time period between T₄ and T₅ is greater than a predefined Minimum Training Time, the features of the person 110E from that path 116E will be recorded. The features recorded may include size of the person, color, color histogram, color model, direction, velocity and other features and those features may be included in a multi-index file Fₑ.

FIG. 12 illustrates an exemplary staff identification in the data processing unit 104 consistent with the disclosed embodiments. As shown in FIG. 12, the features in the file Fₑ are compared to the features in previously stored files Fₑ₁, Fₑ₂ . . . Fₑₙ. The letter “n” represents any positive integer, which indicates the number of the files that are already stored in the cache 310. The cache 310 may be a part of the storage unit of the data processing device 306. The file Fₑᵢ (i may be any number between 1 and n) is a file previously stored in a cache 310 in the data processing device 306. The file Fₑᵢ is similar to the file Fₑ in that it includes the features of a person who previously stays in the staff zone 134 longer than the predefined Minimum Training Time. Each file has a time stamp Tₑᵢ, (i may be any number between 1 and n).

If there is a match, for example, Fₑ matches file Fₑ₁, the person 110E is labeled as the same person that appeared in the past. The value of appearance (Vₐ) of the person 110E is increased by one and the timestamp Tₑ₁ of the Fₑ₁ file is updated with the current time T₅. If there is no match, the Fₑ file is stored in the cache 304 as a new file Fₑ₍ₙ₊₁₎ and the time T₅ is stamped as Tₑ₍ₙ₊₁₎. The cache 310 may be of limited size. If a new file Fₑ may not be stored due to size limitation of the cache 310, the oldest file Fₑᵢ may be removed from the cache 310 based on least recently used (LRU) algorithm. That is, the file Fₑᵢ with the oldest time stamp Tₑᵢ will be discarded to make room for the new file Fₑ.

If the Vₐ of the person 110E exceeds the Minimum Training Number, the person 110E may be recognized as a staff. The features of the person 110E will remain in the person feature cache 310, and the decision that this person is a staff member is recorded in the cache 310 as well. Any subsequent appearance of the person 110E in the same camera will be identified by the person feature cache 310 as a staff member. For either counting statistics or the tracking statistics, the statistics for the person 110E will not taken into account for customer behavior analysis. As a result, the activities from the person 110E will not impact the customer behavior statistics.

The behavior data of the person 110E may also be collected, processed, and saved separately for other purposes. With the staff identification, the staff tracking data, including the staff traffic path, staff stops and staff dwell time, may be collected, processed and stored. The creation of the staff 110E traffic path/stops/dwell time is identical to the process described above for the customer 110C, except that the data are for the identified staff 110E. The resulting traffic path/stops/dwell time will then be indication on the activities of the staff 110E, such as his moving direction, stop point and others. Such data may provide additional insights on the behavior pattern of the staff, which may be adjusted to enhance the service in the store.

With the identification of staff, the staff-to-customer interactions may be detected and the data on such interactions may be collected and analyzed. FIG. 13 illustrates an exemplary staff-to-customer interaction detection in the data processing unit 104 consistent with the disclosed embodiments. As shown in FIG. 13, a customer interaction zone 136 is defined as a circle area that is formed with the customer 110C being center of the circle and with a predefined radius R. If the staff 110E is within the interaction zone for longer than Minimum Staff Interaction (MSI) time, a staff-to-customer interaction event occurs. The interaction value Vᵢₙₜ for the staff 110E is increased by one. When an interaction is detected, the interaction value Vᵢₚ on the particular pixel 126 is increased by one. The resulting pixel map then may describe graphically the spatial pattern of staff-customer interactions within the store.

FIG. 14 illustrates an exemplary process 600 performed by the data processing unit 104 to create staff-to-customer interaction statistics consistent with the disclosed embodiments. At beginning, the customer interaction zone 136 may be identified for the customer 110C (602). The data processing device 306 may decide whether the staff 110E is in the customer interaction zone 136 (604). If the staff 110E is not in the customer interaction zone 136, the interaction value interaction value Vᵢₙₜ for the staff 110E and the interaction value Vᵢₚ on the particular pixel 126 may remain unchanged (610). If the staff 110E is in the customer interaction zone 136, the data processing device 306 then may decide whether the staff 110E stops in the customer interaction zone 136 over the MSI (606). If the time the staff 110E stops in the customer interaction zone 136 does not exceed MSI, the interaction value interaction value Vᵢₙₜ for the staff 110E and the interaction value Vᵢₚ on the particular pixel 126 may remain unchanged (612). If the time the staff 110E stops in the customer interaction zone 136 exceeds MSI, the interaction value interaction value Vᵢₙₜ for the staff 110E and the interaction value Vᵢₚ on the particular pixel 126 may be increased by one (608).

In addition to the statistics described above, other types of statistics may also be created. FIG. 15A illustrates an exemplary touch statistics creation performed by the data processing unit 104 consistent with the disclosed embodiments. A touch is a gesture of the customer 110C when he or she reaches out to products displayed on a fixture 112 in the store. The fixture 112 may be a vertical fixture, such as a product shelf or a rack, or a horizontal fixture such as a table with products displaying on top. As shown in FIG. 15A, when the customer 110C touches a piece of merchandise on the fixture, a sensor 302 captures the gesture. The sensor 302 for collecting touch statistics is usually mounted as overhead cameras on top of the fixture 112 and looking straight down. Other types of sensors, such as a stereoscopic or time of flight sensor may also be used, which may be mounted from the side at an angle on a wall or other fixture so the sensor may also capture the gesture between the customer and the fixture from the side and/or horizontally.

As shown in FIG. 15A, the sensor 302 captures an image frame 138. Similar to the mechanism described in FIG. 6 and the accompanying text, an image file 140 may be created in the data processing device 302 using a background removal/moving object detection. Common pattern recognition algorithm may be applied to determine if a gesture occurs. If a gesture is detected, the associated moving object, for example, a hand 110H, is recorded. A common object tracking algorithm is then applied to track the movement of the hand 110H and thus, the gesture. Thus, the gesture from the same customer 110C will only be counted once.

As shown in FIG. 15A, the customer 110C is located within a touch zone 142. The touch zone 142 is defined in the view of the sensor 302 to monitor the fixture 112. It is typically a polygon geometrically in the sensor view, and an edge 144 is defined as the base line, which may be where the customer 110C stands. In addition, the orientation of the fixture 112 (vertical or horizontal) is also specified for each of the zone. As shown in FIG. 15A, the touch zone 142 is a rectangle with the baseline 144.

Tracking the moving object 110H, the farthest point 146 from the base line 144 of the zone may be detected. The farthest point 146 falls within a pixel 148. The touch value of the pixel 148, Vₜ, is increased by one.

The touch data collection is performed per sensor basis, and therefore the resulting pixel data is stored for each of the sensors 302 independently. Similar to counting and tracking statistics, at the beginning of the predefined time period, Vₜ is set at zero. The values created may be stored temporarily in the data processing unit 104 and transferred to the data storage unit 106 and/or reporting unit 108 at pre-set intervals. After the time period of data process, these values are reset at zero for the next round of data processing. Or newer values may be simply input into the temporary store memory to overwrite the older data. FIG. 15B shows an exemplary process 500B to create a touch statistics performed by the data processing unit 104 consistent with the disclosed embodiments.

As shown in FIG. 15B, at beginning, the statistics value is set at zero at the beginning of a predefined time period (514). The predefined time period may be a day, a week, a month, or any other predefined period. The data processing unit 104 may input images or video from the data capturing unit 102 (516). The data processing device 306 may then recognize a gesture (518). This may be achieved by using a background removal/moving object detection and/or pattern recognition algorithm. The data processing device 306 may create customer touch statistics (520). The customer touch statistics may be output to data storage unit 106 and/or the reporting unit 108 (522).

FIG. 16 illustrates an exemplary bailout statistics creation performed by the data processing unit 104 consistent with the disclosed embodiments. A bailout is an event that a person enters a store or an area in a store and leaves without purchasing. A bailout behavior may be a person turning around and leaving via the direction he comes or may be a person passing through the store or area of the store, entering and leaving directly to the left or right without selecting a product.

To detect bailout, a typical non-bailout and a typical bailout path a customer would take under a sensor are defined. As shown in FIG. 16, a U turn path 150 may be defined as a typical bailout path at an entrance, and a path 152 going through may be defined as a typical non-bailout path. A customer 110B with a traffic path 154, which is similar to the typical U turn path 150, is thus recognized as a bailout customer. By contrast, a customer 110NB with a traffic path 156, which is similar to the typical non-bailout path 152, is recognized as a non-bailout customer. For a predefined area 158, the bailout value V_{b} is increased by one if the customer 152 is detected. For each area bailout data are collected, one or more typical bailout paths and one or more typical non-bailout paths may be decided empirically.

A bailout event at a fixture may be defined by the combination of bailout as defined by typical bailout path comparison and no touch event. That is, a bailout event occurs when a customer takes the typical bailout path and does not touch any merchandise on a fixture.

A process similar to that as illustrated in FIG. 10 and described in accompanying text may apply to the bailout statistics to create a report. In short, similar to counting and tracking statistics, at the beginning of the predefined time period, V_{b} is set at zero. After the time period of data process, the value is reset at zero for the next round of data processing. Or newer values may be simply input into the temporary store memory to overwrite the older data.

FIGS. 17A and 17B illustrate an exemplary view statistics creation performed by the data processing unit 104 consistent with the disclosed embodiments. As show in FIG. 17A, a sensor 304 capable of face image capturing may be installed on the fixture 112 horizontally at average head height. The sensor 304 is usually installed side-by-side with an object such as a display, point of purchase, a media or a certain selected product. The sensor 304 may be used, in combination with the data processing unit 104, to measure the frequency and time duration of the objects being looked at (view number and view time).

At a certain time point T₆, the face image of the customer 110C is captured by the sensor 304 on an image frame 160. The image frame 160 is transmitted to the data processing device 306. In the data processing device 306, a pattern recognition algorithm is applied on each frame 160 in conjunction with a statistical model including a set of faces to create a file F_{c} with a set of classification values and a feature value given the face on the frame 160. Thus, a face may be uniquely identified by the feature value. The pattern recognition algorithm may be applied to conventional security camera images and three dimensional sensors. For the images created by different type of sensors, different statistics model may be used to create the unique set of feature values for the face image. For example, a statistics model of pixel color image of faces may be used for a two dimensional image, whilst a statistics model of depth contour of different faces may be used for a three dimensional image.

FIG. 17A illustrates an exemplary classification values and feature value creation for a face consistent with the disclosed embodiments. A face image file 160A is compared to a set of faces, which may include more than one thousand male faces and one thousand female faces with predefined classification values for each of a set of features. A pattern recognition algorithm estimates which set of faces from the same classification are closer to the face image file 160A for a certain feature, and the face in the image 160A is given the classification value for the certain feature. The face image file 160A may be given the classification value on the gender, the age, the color, and any other pre-determined feature. For example, if the face on the image file 160A resembles the male faces in the database more, the classification value for the gender feature for this face may be male. The classification value may be used for statistics based on classification such as gender, age group, ethnicity, and other classifications.

In addition to the classification value, a face may have a feature value. A feature value may be expressed in the form of a set of number that can identify the face uniquely. The feature value may be generated through Linear Discriminative Analysis (LDA) or Principal Component Analysis (PCA) or any other appropriate algorithm.

FIG. 17B illustrates exemplary creation of view number (Nᵥ) and view time (Tᵥ) statistics performed by the data file consistent with the disclosed embodiment. The data processing unit 104 includes a buffer list 312. The buffer list 312 contains files F₁, F₂ . . . Fₙ, each of which represents a face that has been captured by the sensor 304 with a unique set of feature values and has a time stamp Tᵥ₁, Tᵥ₂ . . . Tᵥₙ, respectively. The file F_{c} is then compared to each file in the buffer list 312. If the file F_{c} has no match with files from the buffer list, the face represented by the file F_{c} is considered as a new face. The view number (Nᵥ) is increased by one and the time point T₆ is recorded as the start time of view for the new face. If the file F_{c} matches a file that is already in the buffer list 308, for example, file Fᵢ, the face represent by the file F_{c} is considered as an “old” face. The view number (Nᵥ) remains the same, but the view time is increase by the difference between the time point T₆ and the previous time point Tᵥᵢ for the file. Meanwhile, T₆ replaces the previous time point and is kept in the record.

For each file Fᵢ (i may be any number between 1 to n), if after Max Face Disappear number of frames, no F_{c} matches the file Fᵢ, the face represented by the file Fᵢ is considered to have left the sensor view and the file Fᵢ will be discarded from the list. The view time will then be recorded.

FIG. 18 illustrates an exemplary process 500C to create a view number and view time statistics performed by the data processing unit 104 consistent with the disclosed embodiments. As shown in FIG. 18, at beginning, the statistics value is set at zero at the beginning of a predefined time period (524). The predefined time period may be a day, a week, a month, or any other predefined period. The data processing unit 104 may input images or video from the data capturing unit 102 (526). The data processing device 306 may then recognize a face (528). The data processing device 306 may create customer view number and view time statistics (530). The customer view number and view time statistics may be output to data storage unit 106 and/or the reporting unit 108 (532).

In addition to the view number and view time statistics, the face recognition algorithm described above may also be used to track the path the customer 110C takes in the store. The face image of the customer 110C may be capture by different sensors 304 around the store and may be recognized by the pattern recognition algorithm. The statistics/data about the customer 110C within the shop may be created and represented on the map.

The statistics created in the data processing unit 104 may be first stored in a data temporary storage within the data processing unit and then transferred to the data storage unit 106 and/or reporting unit 108. FIG. 19 illustrates an exemplary data temporary storage in the data processing unit 104 consistent with the disclosed embodiments. The data processing unit 104 creates and/or collects all the statistics/data as described above. All data/statistics from the data processing unit 104 are tagged with the relevant sensor ID and zone ID to uniquely identify the source of the data. A database 314 in the data processing unit 104 may store the statistics/data for a certain period of time. The data stored in the database 314 is periodically transferred to data storage unit 106 or directly to reporting unit 108. Older data in the database 314 may be automatically overwritten to accommodate newer data.

FIG. 20 illustrates an exemplary process 700 performed by the data processing unit 104 for the temporary storage of the statistics. At beginning, the statistics are created (702). The statistics are temporarily stored in the database 314 (704). The data processing unit 108 then decides whether it is time to transfer the data (706). The data are transferred to the data storage unit 106 and/or the reporting unit 108 if the time point for transfer is reached (708). Otherwise, the files remain in the database (710).

The customers behavior data collected and/or created as described above may be transferred to the reporting unit 108 for further processing and/or analyzing. These behavior data may be integrated with other data. Customer behavior data/statistics alone are usually not sufficient for an informed analysis as to the patterns and/or decision making within the store. Data from other sources may be integrated with the behavior data/statistics at the reporting server so the user may have a better understanding as to the relationship between the customer's behavior and data from other data systems in the store.

FIG. 21 illustrates an exemplary integration of different type of data in the reporting unit 108 consistent with the disclosed embodiments. As shown in FIG. 21, the customer behavior data/statistics 162 may be integrated with the point of sales data 164, staff data 166, and other customer interaction data 168.

FIG. 22 illustrates an exemplary integration of point of sales data 164 with the customer's behavior data 162 in the reporting unit 108 consistent with the disclosed embodiments. As shown in FIG. 22, for a fixture 112, the customer's behavior data show the number of passers by, impression, stops, and bailout data for the fixture 112. “Passers by” are the customers who pass a pre-defined area, and the number of the passers by is the counting statistics for the pre-defined zone. “Impression” indicates that customers look at certain product, display, media or others, and the number of the impression is the view number statistics for the product, display, media or others. The point of data sales data show the actual number of purchases for the merchandise displayed on the fixture 112, which is the number of the converted. Integration of the two types of data allows the calculation of the conversion rate for the fixture 112. The data may be presented as a column chart 170, or a pie chart 172. Similarly, conversion rate may be obtained at various levels, such as whole store, per floor, per zone or even per product.

Similarly, other data integrations may reveal the relationship between the number of staff in the store and customer's behavior. Such integration of data would provide insight on staff to customer ratios as an indication of the potential service levels in the store.

Other types of interaction between the customers and the shopping environment may also be integrated. Such interactions may include the activity patterns such as QR or bar code scanning by a customer, presenting coupons, seeking service help, seeking promotion information, joining a lucky draw, pre-ordering products, joining online promotion activity, checking product availability or checking prices. Since the locations of these codes/patterns may be known in advance, the data/statistics may be categorized and marked on a location on the floor plan as well. Other interaction may include customer's phone call and/or interaction with online system in a store. The data/statistics on such interaction occurrences may also be integrated to the system.

Tracking statistics, counting Statistics, view number, view time, and bailout statistics are numerical data. Therefore, they may be presented in a numerical data presentation such as conventional graph, table and dashboards as such presentations are created by the reporting unit 108. FIG. 22 illustrates an exemplary presentation of this type.

As described above, the numerical data/statistics that may be collected/created are identified on certain predefined zone within the store. For example, there may be the main entrance zone, fitting room zone, fixture zone, and other zones. The analysis of the statistics between different zones may be presented in a funnel fashion based on these locations. FIGS. 23A-23C illustrate exemplary presentations created by the reporting unit 108 consistent with the disclosed embodiments. As shown in FIG. 23A, the main entrance traffic, the fitting room traffic, and the number of sales are presented in a “funnel.” As shown in FIG. 23B, the number of views at the entrance, the number of views near a fixture, and a number of views at a display are presented in a “funnel.” These numbers may be further categorized based on gender, age and/or ethnicity. As shown in FIG. 23C, the number of views at the entrance and the number of views at the fitting room are presented in a funnel. These numbers may be further categorized based on gender, age and/or ethnicity.

The analysis of the statistics described above may also be presented as comparison between two adjacent elements for various data/statistics. FIG. 24 illustrates an exemplary adjacency presentation consistent with the disclosed embodiments. The element may be a fixture, a product, a display, or a zone. As shown in FIG. 2r, there are two adjacent elements 112A and 112B. For these two elements, the adjacent zones for statistics analysis are a zone 174A for the element 112A and a zone 174B for the element 112B. The correlation factor for a particular statistics value may be expressed as the ratio between the values for the zone 174A and the zone 174B. For example, the zone 174A may have a pass value V_{cA} and the zone 174B may have a pass value V_{cB}. The correlation factor for the pass value, CF_{c}, between the element 112A and 112B may be expressed as the quotient of V_{cA} divided by V_{cB}, i.e., CF_{c}=V_{cA}/V_{cB}. The comparison of other statistics, such as stop statistics, conversion statistics may be expressed in a similar manner. Other types of expressions may also be used.

A relatively high level of correlation between two adjacent elements may usually be a result of the physical relationship between such two elements. Such correlation factor or change of a statistics value may provide indications on whether two adjacent elements are positively correlated or negatively correlated, known as adjacencies analysis. Experiments may be performed to determine the relationship between different types of products displayed adjacently to gain insight based on such adjacencies analysis. As a result, the products display may be optimized to achieve a higher uptake of different products (an effect known as adjacencies). Similarly, the relative performance of competitive products of similar nature may be better understood based on such data/statistics.

The data/statistics may be presented in other format. FIG. 25 illustrates an exemplary presentation of the traffic path statistics in map data layer consistent with the disclosed embodiments. The map data layer presents the pixel data map as color-coded pixels. The color then indicates the value associated with the corresponding pixel in the data map. A brighter or warmer color may be used to indicate a higher value and a darker or cooler color may be used to indicate a lower value. The result is a color-coded map that looks similar to a weather map. As shown in FIG. 25, an area 176 has the brightest color, which indicates that the area 176 has the highest value of traffic path. An area 178 has the dullest color, which indicates that the area 178 has the lowest value of traffic path. An area 180 has a color between those of the area 176 and the area 178, which indicates that the area 180 has a medium value of traffic path.

Map data layer is a store-wide layer that combines data from related sensors into one single map so that the user may view the result at a whole store level instead of at individual sensor level. The map data layer is a layer on top of the actual floor plan/shelf image. In the case of tracking statistics, it will be the traffic path/stops/dwell time map on the floor plan, whilst it will be a shelf image for the touch map. The image may be created from the actual two-dimensional or three-dimensional drawing of the store or the planogram of the shelf, or by stitching images from the sensors installed in the store. FIG. 26 shows an exemplary process 800A performed by the reporting unit 108 to create a map data layer consistent with the disclosed embodiments.

As shown in FIG. 26, at beginning, the reporting unit 108 obtains the statistics for a predefined time period (802). The customer behavior statistics 162 may be obtained from the data processing unit 104 and/or data storage unit 106. Other statistics, such as the sales data 164, may be obtained from other sources, such as point of sales. The reporting unit 108 may also match the coordinates on the floor and the sensor view image, known as coordinate mapping (804). The coordinate mapping is used for each of the sensor data to transform the coordinate in the sensor image into coordinates in the floor plan/shelf image. The transformation also applies the correction to camera distortion determined from the coordinate mapping stage. The statistics values may be assigned to pixels and/or predefined zones on the floor (806). For a particular pixel and/or a predefined zone, the statistics may be summed up. The reporting unit 108 may also integrate various statistics (808). The reporting unit 108 may further create a map data layer report (810). The report may present the statistics on the floor in various formats.

FIG. 27 illustrates an exemplary process 800B performed by the reporting unit 108 to assign a statics value for a pixel on the floor consistent with the disclosed embodiments. As shown in FIG. 27, at beginning, the reporting unit 108 may overlay the sensor images on the floor (812). The reporting unit 108 may determine whether there is an overlap between the sensor images (814). If there is the overlap, the reporting unit 108 may assign the highest statistics value from one sensor to the overlapping pixel (820). If there is no overlap, the statistics value for a pixel is determined using interpolation. Thus, the reporting unit 108 assigns each pixel a statistics value for a particular statistics for the pre-defined time period to create a pixel data map (818).

FIGS. 28A-28C illustrate an exemplary sensor mapping performed by the reporting unit 108 consistent with the disclosed embodiments. As shown in FIG. 28A, actual images C1, C2, C3, C4, C5 and C6 from each of the sensors are overlaid on the floor map of the pre-defined zone 114. The user may match the images C1, C2, C3, C4, C5 and C6 with the actual coordinates on the floor plan/shelf image using an interface provided by the reporting unit 108. The coordinate mapping also includes perspective correction to compensate for any optical distortion commonly found in sensors. After completing this process, the user establishes the correlation between each of the sensors and a set of coordinate on the floor plan/shelf image.

Typically, an overlapping area O1 may be present between the two or more sensor images, such as C1 and C2, in order to avoid gap on the floor plan. To avoid double or multiple presentations of the data/statistics for the overlapping area O1, only the data/statistics from the sensor image with the highest value is presented. FIG. 28A illustrates an exemplary data selection in overlapping area consistent with the disclosed embodiments. As shown in FIG. 28A, the area O1 is covered by sensors C2 and C3. Assuming the traffic path values for the area collected from these two sensors are V_{C2} and V_{C3}, and further assuming that V_{C2} is the greater than V_{C3}, V_{C2} is selected to represent the traffic path value for the area O1. Other statistics values in the overlapping area O1 may be determined similarly.

The coordinate mapping (804) as illustrated in FIG. 26 may be performed on discrete pixels. It is possible that the pixel on the floor is transformed to a point between the pixels in the sensor image. As shown FIG. 28B, each floor pixel P may be located between four sensor image pixels SP. FIG. 28 C illustrates the determination of a certain statistics value for the pixel P. As shown in FIG. 28C, the adjacent sensor image pixels are pixel SP1, SP2, SP3 and SP4. The P may then be calculated using interpolation or a linear combination of the values from pixel SP1, SP2, SP3 and SP4. For example, as shown FIG. 28C, the four sensor image pixels SP1, SP2, SP3 and SP4 may form a rectangle and the floor pixel P may be located within the rectangle. If the ratio of distance from the projections of pixel P on the two sides of the rectangle to pixel SP3 to the length of the sides are α and β, value for pixel P may be determined by a formula α*(β*SP3+(1−β)*SP4)+(1−α)*(β*SP2+(1−β)*SP1). The formula used to determine a particular value for the pixel P may be determined empirically.

After the processing described above, a value is created for every pixel from the area on the floor plan/shelf image that is covered by one or more sensors 302. The result is a seamlessly and properly merged pixel map on the floor plan/shelf image space.

A color scheme may be utilized to facilitate the visualization of the pixel data. The user may select a color scale, which may ascend from a darker color to a lighter color or from a cooler color to a warmer color corresponding to the increasing value. Value of each pixel data from the floor plan/shelf image is then mapped to the color scale for the final display. The mapping from the pixel data to the color scale may be linear, but may also be based on logarithmic function or other types of scale.

The customer's behavior data/statistics may also be presented in a fixture layer. Similar to the map data layer, the fixture layer is also a store-wide presentation of customer behavior data/statistics. In the fixture layer, the data are grouped by the fixture layout in the store. A fixture layer presentation displays the data in a manner that is more intuitive and easier to interpret to facilitate the understanding of the customer's behavior and potential improvement.

FIG. 29 illustrates an exemplary fixture layer presentation of customer's activity in a store consistent with the disclosed embodiments. The percentage figure beside each fixture is the percentage of activities at this fixture of all activities at all the fixtures in the store. Activity is defined as pass, dwell or stop. The fixture with higher percentage is represented using brighter red color. The fixture with lower activity is represented using duller color.

To create the fixture layer, a fixture layout may be defined first. FIGS. 30A and 30B illustrate an exemplary fixture layout definition consistent with the disclosed embodiments. As shown in FIG. 30A, a fixture area 186 is defined on the floor plan image that corresponds to the actual fixtures 112 in the store. The area 186 may be larger than the fixture 112 so that it covers area where people stop and dwell in front of fixture 112. As shown in FIG. 30B, in the case of a touch map, the defined area 186 may also include the product display area 188 on the shelf image. A fixture library may be stored in the reporting unit 108, which includes display table, round table, racks, shelf, feature wall, and other fixtures. Each fixture area is then assigned to one of the fixtures in the library. The fixture areas for all the fixtures in the store constitute the fixture layout.

The processes as illustrated in FIG. 27 and as described in accompanying text may similarly apply to fixture layer for the creation of one seamless pixel data map. With the combined pixel data map in the floor plan/shelf space, the values of all the pixels within each of the fixture area 186 are summed up to create a value for the fixture area 186. The value could be for traffic path, stops, and dwell time. In case of touch statistic, the values of all the pixels within the area 188 are summed up too. FIG. 31 shows an exemplary process 800C performed by the reporting unit 108 to create a fixture layer consistent with the disclosed embodiment.

As shown in FIG. 31, at the beginning, the reporting unit 108 may create a pixel data map (824). The reporting unit 108 may also define the fixture area 186 (826). The reporting unit 108 may then create a statistics value for the fixture area 186 (828). The reporting unit 108 may further present the statistics in a fixture layer (830).

The values for each of the fixture may be presented in a variety of ways. For example, the value may be presented as a figure on top of each fixture, or as a percentage share on top of each fixture, or as a percentage change of values between time periods on top of each fixture. The fixture may be color-coded to indicate the value for each fixture. A lighter/warmer color may be used to indicate higher value, and a darker/cooler color may be used to indicate a lower value. A color scale may be first selected, and the values from the fixture areas are mapped to the color linearly or based on other functions such as a logarithmic scale. The fixture may also be color-coded to indicate the change of values between time periods for each of the fixture areas. For example, color red may be used to indicate an increase, and the shade of red may be used to indicate the degree of changes between the periods with the lighter color representing the bigger change. On the other hand, color blue may be used to indicate a decrease, and the shade of blue indicates the degree of changes between the periods.

FIGS. 32-35 illustrate exemplary fixture layer presentations consistent with the disclosed embodiments. As shown in FIG. 32, the number of stops made by customer at each fixture and the percentage of the stops at a fixture over the total stops are presented in the fixture layer. As shown in FIG. 33, the dwell time in seconds at each fixture and the percentage of the dwell time at a fixture over the total dwell time are presented in the fixture layer. As shown in FIG. 34, the percentage changes of number of stops at each fixture are presented. As shown in FIG. 35, the percentage changes of dwell time at each fixture are presented.

The fixture layer presentation may also be used to present other data/statistics. For example, the sale data from the point of sales system may be integrated. The conversion rate of fixture specific goods to the number of stops at the fixture may be calculated and presented for each fixture. Other data/statistics may be presented for each fixture include the average dwell time for a fixture, the views and view time for each fixture, and the percentage of views for a fixture over the number of people entering the store. These data may be further categorized based on gender, age, and/or ethnicity.

A three-dimensional map may also be created to present the data/statistics. To create a three-dimensional map, a three-dimensional model of the store is first created through three dimensional scene creation tools or the CAD drawing of the store. The data map layer and fixture layer may be created as described above. The layer may then be overlaid onto the three-dimensional model. For each of the surfaces in the three dimensional map, the corresponding data map layer or fixture layer is created. For example, the traffic path, stops, and/or dwell time value may be mapped to the floor in the three-dimensional model. The touch value of each fixture may be mapped to the shelf or table. The user may navigate in the three-dimensional model as if navigating in the store in person.

FIG. 36 illustrates an exemplary three-dimensional map presentation consistent with the disclosed embodiments. As shown in FIG. 38, there are three fixtures 112C, 112D and 112E in the predefined area 114. The traffic path statistics for the area 114 is presented as a map data layer on the floor. The touch statistics for the fixture 112C, 112D, and 112E, which are Vₜ₁, Vₜ₂, and Vₜ₃, respectively, are presented as fixture layer on the corresponding fixture. A three-dimensional presentation of the pixel map data may allow the user to view the data within the store in a realistic way.

The processes as illustrated in FIGS. 26 and 31 and described in accompanying text may be similarly applied to create a three-dimensional map presentation. As shown in FIG. 38, the traffic path statistics are present in a map data layer created in a process similar to the process 800A. The touch statistics are present in a fixture layer created in a process similar to the process 800C.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

For example, in addition to a store, the system may be used in other types of public places, such as office, school, stadium, restaurant, and other public venues. When used in school, the system may be used to observe the student activities, student-teacher interaction, and others. The data may provide educators with insight on the understanding of student behavior in school.

What is claimed is:

1. A system for analyzing a customer's behavior in a store, comprising:
a data capturing unit having a first sensor configured to capture an image and an activity of the customer at a preset interval in the store during a first time period when the person navigates a pre-defined area;
a data processing unit for processing the image and the activity of the customer, wherein the data processing unit creates a behavior file for the customer from the image and the activity captured by the data capturing unit, and creates a statistics for activities of a plurality of customers in the store for a pixel or a predefined zone in the store for a pre-defined second time period wherein the statistics value is set at zero at the beginning of the pre-defined second time period; and
a data reporting unit for presenting the statistics.

2. The system according to claim 1, wherein:
the data processing unit creates a traffic path for the customer from the image and the activity captured by the data capturing unit and the statistics includes one or more of a tracking statistics, a counting statistics, and a bailout statistics.

3. The system according to claim 1, further comprising:
a staff recognition mechanism to identify a staff member in the store, wherein:
the data processing is configured to perform one or more of a staff member exclusion from the customers statistics, a staff member statistics creation, and a staff-to-customer interaction statistics.

4. The system according to claim 3, wherein:
the staff recognition mechanism identifies the staff member using a behavior pattern recognition algorithm.

5. The system according to claim 1, wherein:
the first sensor captures the customer's gesture before a fixture;
the data processing unit processes the gesture of the customer, and creates a touch statistics for a pixel or a predefined zone.

6. The system according to claim 1, further comprising:
a second sensor configured to capture the customer's face image, wherein
the data processing unit creates a file with a classification value and a feature value for the face image, wherein the feature value uniquely identifies the customer's face; and
wherein the data processing unit creates a view number and a view time statistics.

7. The system according to claim 1, wherein:
the statistics is presented in one or more format of a numerical data presentation, a map data layer presentation, a fixture layer presentation, and a three-dimensional map presentation.

8. The system according to claim 1, wherein:
the reporting unit further presents an analysis of the statistics.

9. The system according to claim 8, wherein:
the analysis of the statistics presented by the reporting unit is one or more of an relationship of the statistics from different zones and an adjacencies analysis.

10. The system according to claim 1, wherein:
the reporting unit integrates a second data from a system that is different to the system for analyzing the customer's behavior in the store with the statistics and presents the integration of the second data and the statistics.

11. A process of analyzing a customer's behavior in a store, comprising:
capturing an image and an activity of the customer at a preset interval in the store during a first time period when the customer navigates a pre-defined area using a data capturing unit having a first sensor configured to capture the image and the activity of the person;
creating a behavior file for the customer from the image and the activity captured by the data capturing unit, and creating a statistics for activities of a plurality of customers in the store for a pixel or a predefined zone in the store for a pre-defined second time period wherein the statistics value is set at zero at the beginning of the pre-defined second time period using a data processing unit; and
presenting the statistics using a reporting unit.

12. The process according to claim 11, wherein:
the data processing unit creates a traffic path for the customer from the image and the activity captured by the data capturing unit and the statistics includes one or more of a tracking statics, a counting statistics, and a bailout statistics.

13. The process according to claim 11, further comprising:
identifying a staff member in the store using a staff recognition mechanism, wherein:
the data processing is configured to perform one or more of a staff member exclusion from the customers statistics, a staff member statistics creation, and a staff-to-customer interaction statistics.

14. The process according to claim 13, wherein:
the staff member is identified using a behavior pattern recognition algorithm.

15. The process according to claim 11, wherein:
the first sensor captures the customer's gesture before a fixture;
the data processing unit processes the gesture of the customer, and creates a touch statistics for a pixel or a predefined zone.

16. The process according to claim 11, further comprising:
capturing the customer's face image using a second sensor, wherein:
the data processing unit creates a file with a classification value and a feature value for the face image, wherein the feature value uniquely identifies the customer's face; and
wherein and the data processing unit creates a view number and a view time statistics.

17. The process according to claim 11, wherein:
the statistics is presented in one or more format of a numerical data presentation, a map data layer presentation, a fixture layer presentation, and a three-dimensional map presentation.

18. The process according to claim 11, further comprising:
presenting an analysis of the statistics using the reporting unit.

19. The process according to claim 18, wherein:
the analysis of the statistics presented by the reporting unit is one or more of an relationship of the statistics from different zones and an adjacencies analysis.

20. The process according to claim 11, further comprising:
presenting an integration of a second data from a system that is different to the system for analyzing the customer's behavior in the store and the statistics, wherein the reporting unit integrates the second data with the statistics.
